(19) United States
(12) Patent Application Publication
(10) Pub. No.: US 2024/0270013 A1
(43) Pub. Date: Aug. 15, 2024

(54) A MECANUM WHEEL MODULE

(71) Applicant: Edwards Vacuum LLC, Sanborn, NY (US)

(72) Inventors: Willie E. Ashe, Hillsboro, OR (US); Brian Matthew Layng, Hillsboro, OR (US); Gregory Ryan Le Mon, Hillsboro, OR (US); Joshua Nathaniel Eric Mak, Hillsboro, OR (US); Sean David Tischler, Hillsboro, OR (US)

(21) Appl. No.: 18/565,296

(22) PCT Filed: Jun. 1, 2022
(86) PCT No.: PCT/IB2022/055119

§ 371 Date: Nov. 29, 2023

(30) Foreign Application Priority Data
Jun. 3, 2021 (GB) 2107964.5

(51) Int. Cl. B60B 19/00; B60B 27/00; B60K 7/00

(52) U.S. Cl. CPC B60B 19/003; B60B 27/0015; B60B 27/0078; B60K 7/0007; B60K 2007/0092

(57) ABSTRACT

A compact mecanum wheel module is disclosed. The mecanum wheel module comprises: a hub that is configured to house a motor. The hub comprises a circular planar portion and a cylindrical portion extending from the circular planar portion. The cylindrical portion forms a base of a rim of the wheel. A plurality of rollers are mounted on and around the base of the rim, the plurality of rollers each comprising a shaft and a rotatable body, the rotatable body being mounted to the shaft via needle bearings.

This application is a national stage entry under 35 U.S.C. § 371 of International Application No. PCT/IB2022/055119, filed Jun. 1, 2022 and entitled “A MECANUM WHEEL MODULE,” which claims the benefit of GB Application No. 2107964.5, filed Jun. 3, 2021 and entitled “A MECANUM WHEEL MODULE,” the entire contents of each of which are incorporated herein by reference.

### TECHNICAL FIELD

The field of the disclosure relates to a mecanum wheel module.

### BACKGROUND

Mecanum wheels have rollers mounted at an oblique angle around their rim in place of a tyre. The rollers are typically at an angle of 45° to the axis of rotation and this configuration of wheel, when multiple wheels are mounted to a vehicle, allows for omnidirectional motion. This makes this type of wheel particularly useful on vehicles that require high maneuverability such as those that need to move in tight and complex spaces. However, where high payloads are to be transported in these spaces, the size of the wheels to support the load increases and this itself becomes a problem in confined spaces.

### SUMMARY OF THE INVENTION

A first aspect provides a mecanum wheel module comprising: a hub, said hub comprising a circular planar portion and a cylindrical portion extending from said circular planar portion, said cylindrical portion forming a base of a rim of said wheel; a plurality of rollers mounted on and around said base of said rim; said plurality of rollers each comprising a shaft and a rotatable body, said rotatable body being mounted to said shaft via needle bearings.

Mecanum wheels are wheels with multiple rollers mounted on the rim at an oblique angle with respect to a circumference of said wheel. Such wheels when mounted on a vehicle and individually controlled allow for omnidirectional movement of the vehicle. The configuration of the wheels with the load going through rollers mounted on the hub and the requirement for individual control of each wheel conventionally make the transport of heavy loads, without unduly increasing the size of the wheel module, challenging. In some examples, the size of a mecanum wheel grows proportionally with the weight capacity, so that wheels able to support payloads of over 300 Kg generally have a diameter in excess of 25 cm and a width of more than 12 cm. In particular, the rollers have conventionally been a limiting factor when increasing the load bearing capacity of the wheels. The increasing load bearing capacity without increasing the size of the wheel has been addressed by the use of needle bearings to support the load bearing rotatable body of the rollers. Conventionally roller bearings have been used for mounting the rotatable body of the roller to the shaft, and although these are generally less expensive than needle bearings, they are also less robust. The inventors recognised that the robustness of the rollers was a limiting factor for load bearing and that in particular the bearings supporting the rollers were a potential point of failure. They addressed this by replacing the conventional roller bearings with needle bearings. Needle bearings have a larger supporting surface area than roller bearings allowing the load that the roller supports to be spread across a larger area, reducing the pressure felt by the bearings and making them able to robustly support higher loads. Furthermore, despite the increased supporting area such bearings are compact.

In addition the provision of the mecanum wheel as an individual module with a hub with a planar surface and rim for supporting the rollers allows for independent removal, servicing and control of the wheel.

In some examples, said mecanum wheel module of this disclosure comprises a low footprint, high load mecanum wheel, said mecanum wheel module comprising a volume of less than 8,500 cm³ preferably less than 8,000 cm³ more preferably less than 7,800 cm³ and being configured to support a load of at least 300 Kg, preferably more than 330 Kg, more preferably more than 350 Kg.

The use of needle bearings to support the rollers and the arrangement of the hub of the mecanum wheel module allows for a low footprint mecanum wheel which can support substantial loads of 300 kg or more in a low footprint of less than 8500 cm³.

In some examples, said needle bearings are located towards either end of said rotatable body and are mounted by press fitting said needle bearings into a recess machined on said shaft.

In some examples, a length of each of said needle bearings is at least 10% of a length of said rotatable body, preferably at least 14%.

Needle bearings have a larger surface area than roller bearings across which the load can be spread which is a factor in allowing them to robustly support higher loads. Having needle bearings which cover a substantial length of the rotatable body helps spread the load across a larger area and allows for a more robust roller.

In some examples, each of said needle bearings are retained in position via a retaining washer.

Although, the needle bearings may be retained simply by the press fit, in some examples a retaining washer is used. Where the rollers are supporting an increased load then increased forces are exerted on the bearings and this could potentially dislodge them, this is addressed with the use of a retaining washer.

In some examples, the mecanum wheel further comprises a thrust bearing between each of said retaining washers and said respective needle bearing.

A thrust bearing may be used between the retaining washer and the respective needle bearing to reduce friction during rotation. The thrust bearing may be made of a softer material than the shaft or bearings, and one impregnated with lubricant, for example brass impregnated with oil may be used. In addition to reducing friction the thrust bearing reduces the stress felt by the needle bearings and increases their useful life.

In some examples, said hub comprises side surfaces of said rim, said side surfaces being inner and outer side surfaces when said wheel is mounted to a vehicle, said outer side surface 1a comprising a radially outer part of said circular planar portion and said inner side surface 1b comprising a ring extending from said cylindrical portion 14 of FIGS. 1 and 2 of said hub.

The hub may comprise side surfaces extending substantially perpendicularly from either edge of the base of the rim and acting as mounting surfaces for the rollers. The outer side surface 1a of the rim may comprise the outer radial portion of the circular planar portion.

In some examples, said mecanum wheel module further comprises a motor configured to drive said wheel module by rotating said hub; said hub comprising a recess configured to receive said motor, one side of said recess being formed of said circular planar portion and the opposing side of said recess being open to receive said motor.

Examples provide the motor within the mecanum wheel module, the motor being configured to drive the wheel. Mounting the motor within the mecanum wheel module allows the mecanum wheel module and its drive mechanism to be a single unit. This makes it particularly compact and removes the requirement for connecting drive shafts. Furthermore, having the motor within the wheel module, makes the module easy to service and replace as a unit, as apart from the mounting mechanism, the only connections used when mounting to a vehicle are power and control cabling. This allows the module to be easily swapped in and out of a vehicle allowing easy servicing and replacement if there is a fault. Furthermore, such a module is compact, independently controllable and can support significant loads.

In some examples, said mecanum wheel module further comprises a mounting component for mounting said mecanum wheel module to a vehicle, said mounting component comprising an attachment portion for attaching to said vehicle and configured to extend over a portion of said rim of said mecanum wheel, and a plate portion facing said open side of said recess, said motor being mounted to said plate portion.

The module may be configured to have a mounting component such that it can be mounted on a vehicle as a single module allowing for easy attachment and disconnection. The attachment portion that attaches the wheel to the vehicle has an upper portion with mounting points and a plate portion which is configured to face the open side of the recess and supports the motor. In this way, the load of the vehicle on the wheel module will pass through the motor.

In some examples, said motor comprises a drive shaft, said drive shaft being attached to said circular planar portion of said hub such that rotation of said drive shaft by said motor rotates said hub, said motor being mounted such that an axis of rotation of said motor passes through a centre of said hub.

The motor is mounted in the wheel so that the axis of rotation of the drive shaft of the motor is in the centre of the hub, the motor being mounted concentric to the rim of the hub.

In some examples, said motor comprises a high load motor, a drive shaft of said motor being mounted on two bearings arranged at different longitudinal positions along said shaft.

As the load of the vehicle passes through the motor to the wheel, in some examples, the motor is a high load motor. Furthermore, as the load is supported at the end of the drive shaft, there is a cantilever effect and effective support may be achieved by having the drive shaft mounted on two bearings arranged at different longitudinal positions along the shaft.

In some examples, said motor is configured to generate a maximum torque of more than 26 Nm preferably more than 30 Nm.

As the mecanum wheel is configured to support high loads, a high torque motor may be used so that the mecanum wheel can move the high loads.

In some examples, said mecanum wheel has a power density of more than 19 kW/m³, preferably more than 22 kW/m³, more preferably more than 24 W/m³.

Examples provide a low footprint, high load bearing, high power wheel with a corresponding high power density. In this regard the wheel volume may be less than 8,000 cm³, the wheel rated torque may be more than 10 Nm, preferably more than 11 Nm, and the maximum speed of rotation may be more than 150 rpm, 15 0.7 rad/s. This provides a power (rated torque X Max speed of rotation) of more than 150 W, and a power density of more than 19 kW/m³.

In some examples, said mecanum wheel further comprises a braking mechanism mounted adjacent to said motor within said recess.

It may also be advantageous if the braking mechanism for the wheel is within the wheel module again allowing for a compact structure and providing the control and driving mechanisms for the wheel to be within the module, improving the ease with which the wheel can be mounted and removed.

In some examples, said mounting component comprises a guard channel for routing wires between said motor and a vehicle, an upper surface of said guard channel comprising said attachment portion, an outer surface of said guard channel comprising said plate portion and an inner surface of said guard channel being arranged to extend adjacent to said inner rim.

One advantage of the modular nature of the mecanum wheel is that the to other working parts of the vehicle with only power and control cable connections. In some cases, they may pass through a guard channel enabling them to be protected from external forces and also allowing them to be neatly routed.

In some examples, said shafts of said roller are steel and said rotatable body comprises an aluminium barrel with a truncated oval cross section coated with an outer polyurethane layer.

One potential limiting factor of many mecanum wheels is the strength of the rollers. These have conventionally been made of polyurethane and this may not be strong enough to support very high loads. Examples provide a rotatable body which has an aluminium barrel with a truncated oval section and this is coated with an outer polyurethane layer. The aluminium provides structure for the polyurethane and resists deformation. This along with high load needle bearings and the high load motor path contributes to a low footprint high load mecanum wheel module.

In some examples, the motor comprises planetary gears within the motor.

In some examples, said hub is formed of machined aluminium.

It should be noted that the hub may be formed of a number of materials, one being aluminium that is both light and structurally strong. The mounting component may also be formed of aluminium although it may be formed of steel, carbon fibre or some other structurally robust and not too heavy material.

In some examples, said portion of said hub that said attachment portion is configured to extend over comprises an entire width of said hub and at least a third of a circumference of said hub.

In addition to providing a mounting point the attachment portion may act as a guard for the vehicle to protect it from any debris thrown up by the wheel. In this regard it may extend over the entire width of the hub and around at least a third of a circumference of the hub.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION OF DRAWINGS

Examples of the present disclosure will now be described further, with reference to the accompanying drawings.

FIG. 1 shows an isometric view of a mecanum wheel assembly according to an example.

FIG. 2 shows a section view of the mecanum wheel assembly with a motor in place.

FIG. 3 shows the section view of an individual roller of the mecanum wheel assembly.

### DETAILED DESCRIPTION

Before discussing the examples in any more detail, first an overview will be provided.

Mecanum wheels allow for omnidirectional movement of a vehicle by the use of rollers mounted around the rim of a wheel in place of tyres at an oblique angle, typically at an angle of 45° to the axis of rotation. The wheels on one side of the vehicle may have the rollers angled in one direction and the wheels on the other side of the vehicle in the opposite direction such that they are mirror images of each other. This provides an angled force on the vehicle from individual wheels and allows directional control by controlling the speed and direction of rotation of the wheels individually. A vehicle with such wheels mounted on it can move omnidirectionally. Examples seek to provide a mecanum wheel module that is both compact and can support high loads, that is loads of over 300 kgs. Such a module would allow substantial loads to be moved in confined and complex spaces. This may be particularly applicable to transporting vacuum system components within a sub-fab.

A mecanum wheel module of examples provides a substantial load capacity, in a small footprint, with actuation components built into the module. Conventionally on vehicles with mecanum wheels the motor driving the wheel extends axially beyond the wheel, into the body of the chassis increasing the space taken up by the mecanum wheel and drive system. Examples avoid the extension of a motor into the chassis, by configuring a custom wheel hub that allows the motor to be mounted inside the volume of the wheel and wheel hub.

Providing a mecanum wheel module where the rollers comprise needle bearings between the shafts and the rotating body distributes the weight across a larger surface area than would be case with roller bearings and allows the rollers to support an increased load. Furthermore, by mounting the motor and brake mechanism within the hub of the wheel, a wheel and drive system is provided that is not only compact but also modular. This allows each wheel module to be fitted, replaced and serviced individually in a simple manner with the attachment or disengagement of a mounting mechanism and control and power cables.

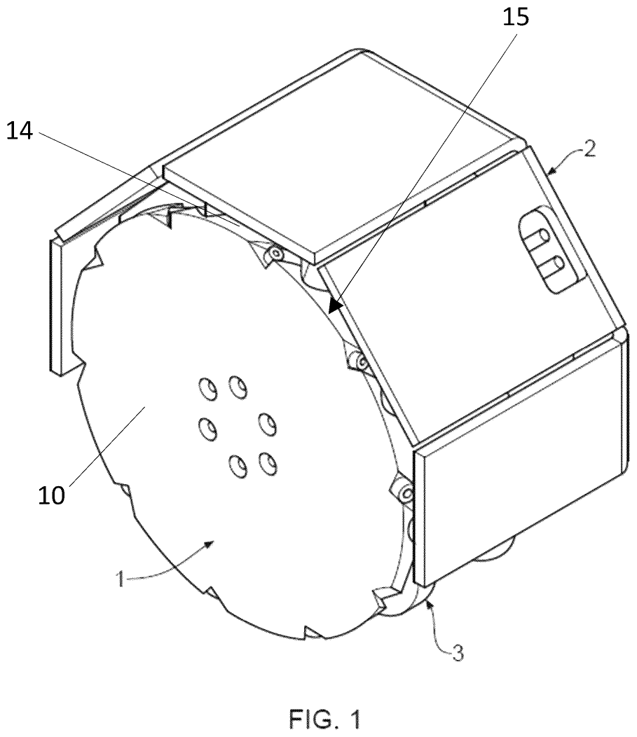

FIG. 1 shows an isometric view of a mecanum wheel assembly according to an example. This shows a spool—shaped aluminium hub 1 which comprises a circular planar surface 10 that forms an outer surface of the hub 1 when the wheel is mounted to a vehicle. Multiple individual rollers 3 are mounted around the base of the rim 15 of the hub. A fabricated aluminium or steel housing 2 that serves as a mounting plate for the mecanum wheel assembly is mounted above and around the upper surface of the wheel. This housing protects the wheel and allows a load path to the chassis of the vehicle that the wheel is attached to, and also has a back plate portion that provides a mounting location for an in-hub motor. The upper surface of this housing provides the surface for mounting the wheel module to the vehicle and also protects the wheel and vehicle from debris thrown up by the wheel. The upper surface of this mounting component or housing is shown here, and there is a back plate that extends behind the wheel opposite to the planar surface 1 and on which the motor is mounted.

The rollers 3 comprise custom, heavy-duty idle rollers, each of which is angled at 45° to the axis of the overall wheel's rotation. These are shown in more detail in FIG. 3.

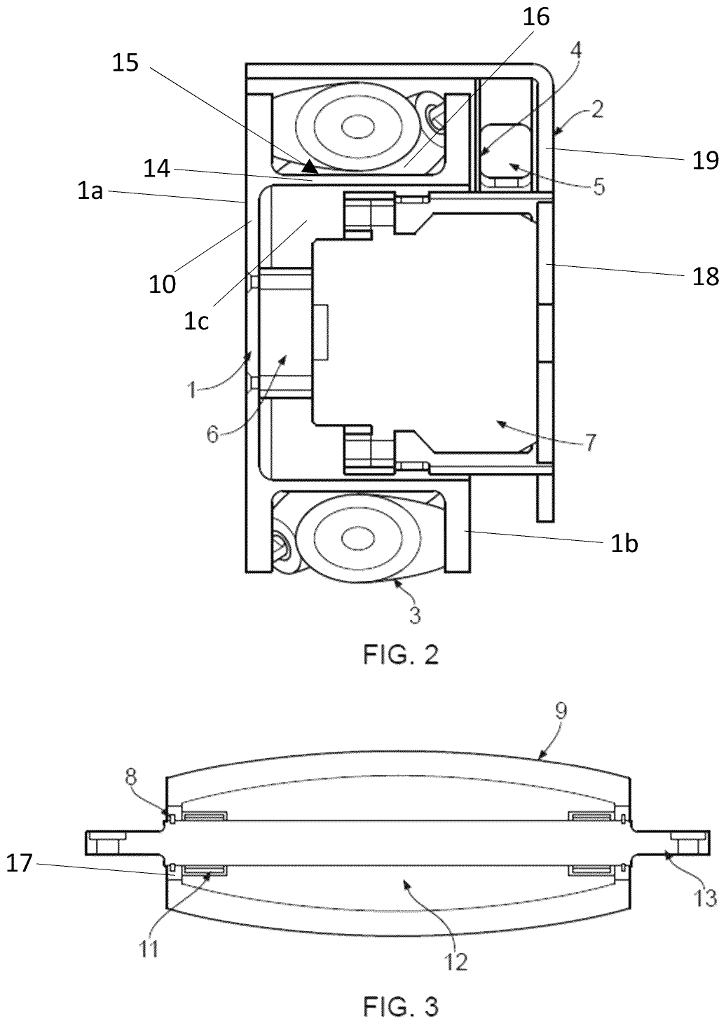

FIG. 2 shows a section view of the mecanum wheel module or assembly. The section view shows the rollers 3 mounted around the rim 15 of the hub 1. The rollers are mounted at an oblique angle to the axis of rotation of the wheel with the shafts of the rollers being attached to the inner and outer ring-shaped surfaces that form the side surfaces of the rim 15 of the hub 1 via screws facing towards the axis of overall wheels' rotation.

A motor 7 is mounted within a recess 1c within the hub 1. The recess 1c is machined into the aluminium hub 1 and this provides a robust housing for the motor. The motor 7 is in this example a high-ratio (˜20:1) electric motor including closed-loop control using Hall effect sensors and incremental encoder enabling the forced rotation of the wheel relative to the wheel housing. The aluminium or steel housing 2 that serves as the mounting component is shown here with both the upper mounting and vehicle protecting section along the upper portion and with the back plate on which the motor 7 is mounted facing the planar surface 10 of the hub. There is a sheet-metal guard portion 4 that protects the cabling from potential objects that may be kicked up by the wheel and lodged into the housing.

Wire routing relief holes 5 that allow power and data cables to safely pass through the body of the wheel assembly to the motor are provided within the guard portion. These cables also allow for the wheel assembly to be easily connected and disconnected from the vehicle. This guide component 5 provides protection for the wires which may be power and data cables and allows them to safely pass through the body of the wheel assembly to the motor.

In this example the motor 7 is mounted at a distance from the planar surface 10 and there is a space 6 for the mounting of a braking mechanism (not shown) allowing the braking of each wheel to be individually controlled.

FIG. 3 shows a section through an individual roller. This section shows a steel shaft 13 that in use is affixed to the inner and outer edges of the rims of the hub at an oblique angle to the circumference. Around this steel shaft 13 is mounted an aluminium barrel 12 with a truncated oval cross-section and this rotates on the shaft 13 and is supported by needle bearings 11. These needle bearings 11 allow high loads to be transferred from the barrel to the shaft while exhibiting low rolling friction. They extend along more than 10% of the length of the roller barrel and this provides a significant surface area over which the force and torque imparted to the shaft via the barrel is spread. A potential weak point of such arrangements will be via the bearings and providing needle bearings rather than roller bearings makes for a more robust mechanism that can support a higher load.

The roller 3 comprises the aluminium barrel 12 and this has a polyurethane outer layer 9. The polyurethane layer exhibits a Shore hardness of 90A. This material is capable of withstanding up to 4,400 N (1.000 lbs) of compression without breaking.

The aluminium barrel 12 provides structural strength to the roller and helps distribute the load applied to the exterior of the polyurethane layer to the bearings. This barrel also controls the shape of the roller itself, which contributes to the wheel's omnidirectional functionality.

The needle bearings 11 are press fitted into a recess 16 machined into shaft 13. The press fitting retains the needle bearings in position but additional retaining means may be used, as the forces on the rollers are high. In this example the additional retaining means comprises a retaining washer 8 and a thrust bearing 17.

Although illustrative examples of the disclosure have been disclosed in detail herein, with reference to the accompanying drawings, it is understood that the disclosure is not limited to the precise example and that various changes and modifications can be effected therein by one skilled in the art without departing from the scope of the disclosure as defined by the appended claims and their equivalents.

1. A mecanum wheel module comprising:
a hub, said hub comprising a circular planar portion and a cylindrical portion extending from said circular planar portion, said cylindrical portion forming a base of a rim of said wheel;
a plurality of rollers mounted on and around said base of said rim;
said plurality of rollers each comprising a shaft and a rotatable body, said rotatable body being mounted to said shaft via needle bearings.

2. A mecanum wheel module according to claim 1, wherein said mecanum wheel module comprises a low footprint, high load mecanum wheel, said mecanum wheel module comprising a volume of less than 8,500 cm³ preferably less than 8,000 cm³ more preferably less than 7,700 cm³ and being configured to support a load of at least 300 Kg, preferably more than 330 Kg, more preferably more than 340 Kg.

3. A mecanum wheel module according to claim 1, said needle bearings being located towards either end of said rotatable body and being mounted by press fitting said needle bearings into a recess machined on said shaft.

4. A mecanum wheel module according to claim 3, wherein each of said needle bearings are retained in position via a retaining washer

5. A mecanum wheel module according to claim 4, further comprising a thrust bearing between each of said retaining washers and said respective needle bearing.

6. A mecanum wheel module according to claim 1, wherein said hub comprises side surfaces of said rim, said side surfaces being inner and outer side surfaces when said wheel is when mounted to a vehicle, said outer side surface comprising a radially outer part of said circular planar portion and said inner side surface comprising a ring extending from said cylindrical portion of said hub.

7. A mecanum wheel module according to claim 1, said mecanum wheel module further comprising a motor configured to drive said wheel module by rotating said hub;
said hub comprising a recess configured to receive said motor, one side of said recess being formed of said circular planar portion and the opposing side of said recess being open to receive said motor.

8. A mecanum wheel module according to claim 7, said mecanum wheel module further comprising a mounting component for mounting said mecanum wheel module to a vehicle, said mounting component comprising an attachment portion for attaching to said vehicle and configured to extend over a portion of said rim of said mecanum wheel, and a plate portion facing said open side of said recess, said motor being mounted to said plate portion.

9. A mecanum wheel module according to claim 7, said motor comprising a drive shaft, said drive shaft being attached to said circular planar portion of said hub such that rotation of said drive shaft by said motor rotates said hub, said motor being mounted such that an axis of rotation of said motor passes through a centre of said hub.

10. A mecanum wheel module according to claim 7, wherein said motor comprises a high load motor, a drive shaft of said motor being mounted on two bearings arranged at different longitudinal positions along said shaft.

11. A mecanum wheel module according to claim 7, wherein said portion of said hub that said attachment portion is configured to extend over comprises an entire width of said hub and at least a third of a circumference of said hub.

12. A mecanum wheel module according to claim 7, wherein said motor is configured to generate a maximum torque of at least 26 Nm preferably of at least 30 Nm.

13. A mecanum wheel according to claim 7, said mecanum wheel further comprises a braking mechanism mounted adjacent to said motor within said recess.

14. A mecanum wheel module according to claim 8, wherein said mounting component comprises a guard channel for routing wires between said motor and a vehicle, an upper surface of said guard channel comprising said attachment portion, an outer surface of said guard channel comprising said plate portion and an inner surface of said guard channel being arranged to extend adjacent to said inner rim.

15. A mecanum wheel module according to claim 1, wherein said shafts of said roller are steel and said rotatable body comprises an aluminium barrel with a truncated oval cross section coated with an outer polyurethane layer.

16. A mecanum wheel module according to claim 1, wherein said hub is formed of machined aluminium.

17. A mecanum wheel module according to claim 1, wherein said mecanum wheel has a power density of more than 19 kW/m³, preferably more than 22 kW/m³, more preferably more than 24 W/m³.
